(19) United States
(12) Patent Application Publication
(10) Pub. No.: US 2009/0234665 A1
(43) Pub. Date: Sep. 17, 2009

(54) System and method for customer feedback

(75) Inventor: Dale W. Conkel, Arlington, TX (US)

Correspondence Address: HEWLETT-PACKARD COMPANY;Intellectual Property Administration, P.O. Box 272400, Fort Collins, CO, 80527-2400, US

(73) Assignee: Electronic Data Systems Corporation, Plano, TX (US)

(21) Appl. No.: 12/075,421

(22) Filed: Mar. 11, 2008

(51) Int. Cl. G06Q 10/00; G10L 15/22

(52) U.S. Cl. 705/1; 704/255; 704/E15.04

(57) ABSTRACT

A method for managing customer feedback. The method includes receiving a recording of spoken customer feedback in a server data processing system and transcribing the customer feedback in the server data processing system to produce a transcript. The method also includes storing the transcript in a customer feedback database and generating and storing an index of the transcript. The method also includes identifying words in the transcript that correspond to predefined keywords and generating a report according to the identified words and the transcript. There is also a corresponding data processing system.

### TECHNICAL FIELD

The present disclosure is directed, in general, to systems and methods for receiving and processing customer or client feedback.

### BACKGROUND OF THE DISCLOSURE

Current Customer Feedback systems do not gather enough information to educate businesses of exactly what customers or clients want as far products or services, or to let the businesses know where they have succeeded or failed in pleasing the customer. In a store setting if a customer wants to make a comment or complaint they are typically given an 800 number or a card to fill out, and they may or may not follow-up because they don't want to take the time to do it.

The customer is more likely to provide helpful feedback if it is as convenient and natural as possible.

### SUMMARY OF THE DISCLOSURE

A disclosed embodiment includes a method for managing customer feedback, comprising receiving a recording of spoken customer feedback in a server data processing system and transcribing the customer feedback in the server data processing system to produce a transcript. The method also includes storing the transcript in a customer feedback database and generating and storing an index of the transcript. The method also includes identifying words in the transcript that correspond to predefined keywords and generating a report according to the identified words and the transcript.

Another embodiment includes data processing system comprising a processor and accessible storage, the data processing system configured to perform the steps of receiving a recording of spoken customer feedback in a server data processing system and transcribing the customer feedback in the server data processing system to produce a transcript. The data processing system is also configured to perform the steps of storing the transcript in a customer feedback database and generating and storing an index of the transcript. The data processing system is also configured to perform the steps of identifying words in the transcript that correspond to predefined keywords and generating a report according to the identified words and the transcript.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment of the customer feedback system can be implemented;

FIG. 2 depicts a simplified block diagram of a system in accordance with various disclosed embodiments;

FIG. 3 depicts a flowchart of a process in accordance with a disclosed embodiment; and

FIG. 4 depicts details of a system in accordance with a disclosed embodiment.

### DETAILED DESCRIPTION

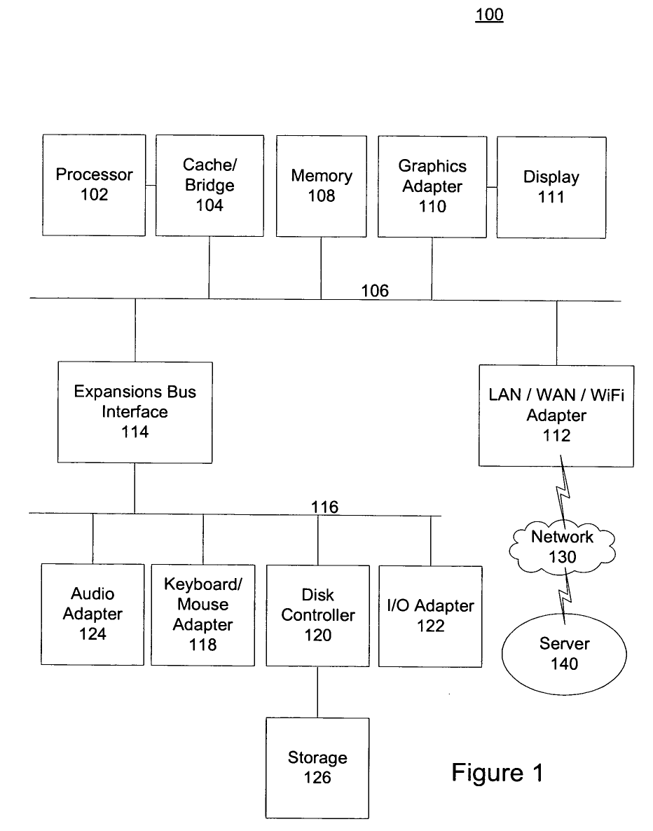

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

The various embodiments disclosed herein include a system that gathers the customer, client, or patient (hereinafter generically “customer”) feedback information easily and naturally from the customer. The customer and/or a employee can speak into a specifically-configured digital voice recorder to relay the customer feedback.

The digital recordings are then, on an occasional or periodic basis, uploaded to a customer feedback system. Once uploaded, the voice recordings are converted/transcribed by the customer feedback system using conventional voice recognition techniques.

The resulting transcript is indexed and saved into the customer feedback system, and the presence of any particular pre-defined keywords is noted. The indexes are also saved in the customer feedback system, and combined into a master index that points back into each transcript. The stored indexes and transcripts can be searched and analyzed by customer service analysts and others, and then decisions can be made based on the feedback, as described herein.

FIG. 1 depicts a block diagram of a data processing system in which an embodiment of the customer feedback system can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. I/O adapter 122 can be connected to communicate with a digital voice recorder or other media input.

Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 can be used to store a customer feedback database, including stored transcripts, digital media files, and feedback indices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with remote system 140, which is also not part of data processing system 100, but can be implemented, for example, as a separate data processing system 100. In some embodiments, the remote system 140 can communicate with the customer feedback system over the network 130.

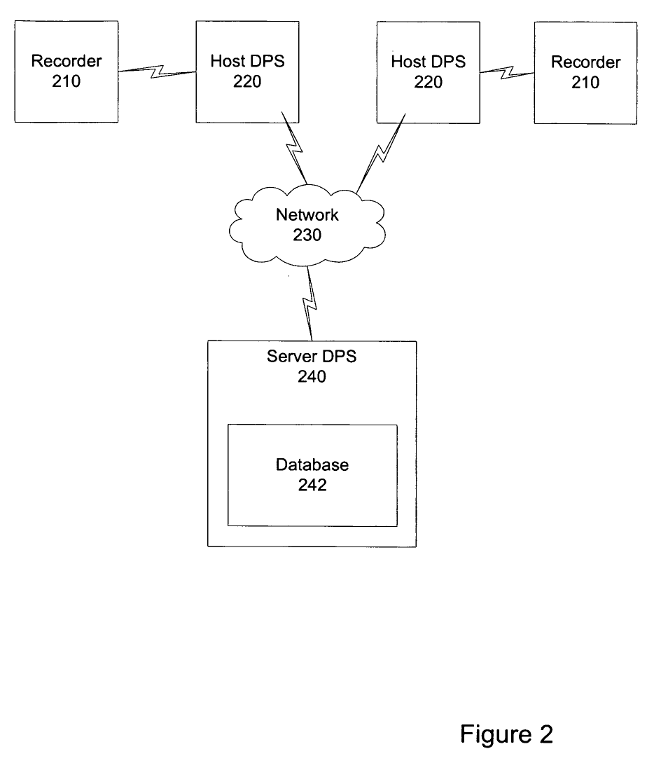

FIG. 2 depicts a simplified block diagram of a system in accordance with various disclosed embodiments. Here, digital media recorder 210 can be connected to host data processing system 220 to upload recorded customer feedback. This connection can be wired, such as by a universal serial bus (USB), other serial, parallel, or network data connection, or can be wireless, such as by a wireless local area network (WLAN), other radio-frequency signal, infrared signal, or otherwise. Note that, as depicted in FIG. 2, in some embodiments there is a plurality of host data processing systems 220, each associated with at least one recorder 210.

In other embodiments, digital media recorder 210 can be part of host data processing system 220, using real-time recording directly into host data processing system 220.

Host data processing system 220 connects over network 230 to server data processing system 240. Network 230 can be any public or private data processing system network or combination of networks, as known to those of skill in the art, including the Internet. Host data processing system 220 and server data processing system 240 can each be implemented, for example, as a data processing system 100. In some embodiments, the functions described below for host data processing system 220 and server system 240 are all implemented in a single data processing system, with no network communication necessary.

In some embodiments, server data processing system 240 includes customer feedback database 242, and performs the transcription, indexing, storage, and reporting functions described herein.

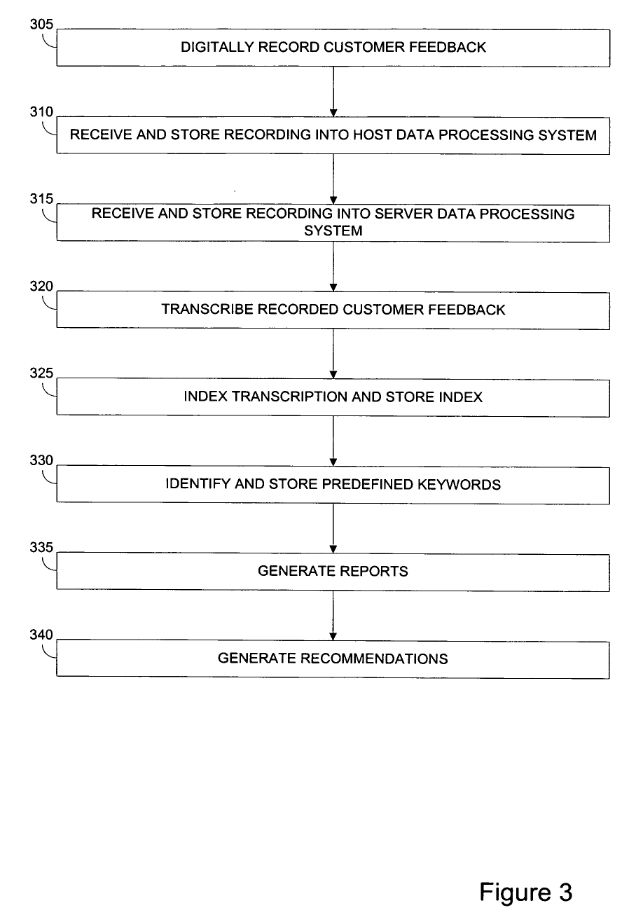

FIG. 3 depicts a flowchart of a process in accordance with a disclosed embodiment.

In step 305, the spoken customer feedback is recorded. This is preferably done using a digital audio recorder, but can be done using another recording device such as a digital or analog audio or video recorder, or can be performed using audio or visual input into a data processing system, which records the feedback and stores it. In various embodiments, the customer can record the feedback directly, alone or in response to questioning, or an employee or other individual can record the feedback after receiving it from the customer by an interview or otherwise.

In step 310, the recording is received and stored into a host data processing system. This can be performed by directly recording into the host data processing system, as above, or by transferring or “uploading” the recording from the recording device.

In step 315, the recording is received and stored into a server data processing system. This can be performed by transmitting it over a network from the host data processing system to the server data processing system. In embodiments with multiple host data processing systems, for example located in different branches of a single national chain store, the server data processing system can receive recordings from a plurality of different host data processing systems.

In step 320, the recording is transcribed by the server data processing system, using known automated audio transcription techniques. The transcription is stored in the customer feedback database in the server data processing system.

In step 325, the transcription is indexed by the server data processing system, and an index of some or all words in the transcript is stored in the customer feedback database. For each word, the index points to the individual transcripts, and the locations within each transcript, in which the indexed word appears. In some embodiments, the index is a combined index of a plurality of transcripts. The index identifies one or more transcripts for each of a plurality of words in the index.

In step 330, the server data processing system identifies words in the transcript, or in the index of the transcript, that correspond to predefined keywords, and stores the identified words. These keywords can include product or service identifiers, pricing identifiers, quality of goods or services identifiers, customer satisfaction identifiers, and others.

In step 335, the server data processing system generates reports corresponding to individual transcripts or multiple transcripts, according to the content of the transcripts, the indexed words, and/or the keywords, so that the issues identified by the customer feedback can be quickly scanned by users. This can be particularly useful where the generated report draws a correspondence between different identified words (each corresponding to a keyword, in some embodiments), such as between an identification of a good or service and the customer's associated comments regarding pricing, quality, satisfaction, and other characteristics. The reports can be output, displayed, transmitted, and/or stored.

In step 335, product and service recommendations are generated based on the reports, the content of the transcripts, the indexed words, and/or the keywords. These recommendations can be generated by the server data processing system or by users. The recommendations can be output, displayed, transmitted, and/or stored.

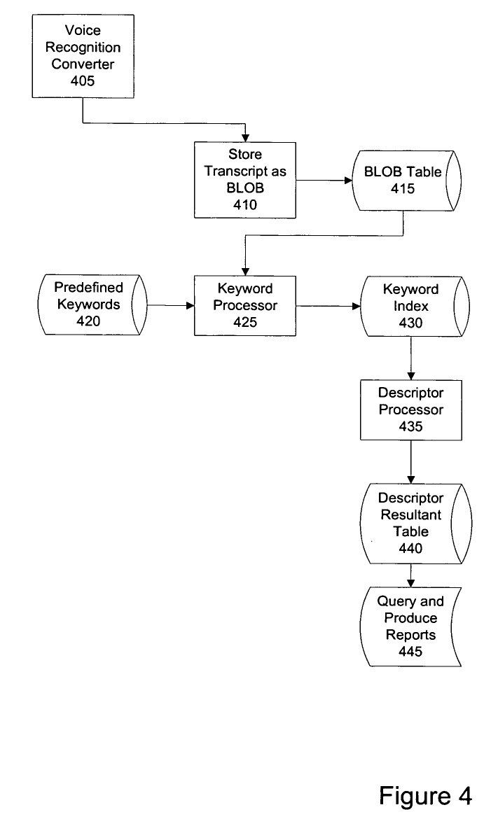

FIG. 4 depicts details of a system in accordance with a disclosed embodiment. After a recording has been uploaded from a recorder 210, a voice recognition converter 405 of the server data processing system transcribes the recording.

The transcript is inserted in a database 242 at 410, such as being stored as a binary large object (BLOB) in BLOB table 415. BLOB table 415 can be part of or stored with database 242. The digital voice recording itself can also be stored in the BLOB table.

BLOB table 414 can be input to keyword processor 425, as are predefined keywords 420. Predefined keywords 420 can have associated positive and negative values, representing whether the recognized keyword indicates generally positive or negative feedback from the customer.

Keyword processor 425 uses the BLOB table 415 and the predefined keywords 420 to determine if any of the predefined keywords are recognized in the transcripts. The keyword processor 425 will insert any recognized keywords into the keyword index 430, along with any associated positive and negative values.

Keyword processor 425 extracts the keywords such as product names, verbs, proverbs and adjectives and assigns a pre-determined positive or negative value to the adjectives and/or other words from the predefined keywords table 420 and inserts records into the keyword index 430.

Descriptor processor 435 then adds up the values of the adjectives (positive and negative) and writes a record to the descriptor resultant table 440.

The data analyst and the server data processing system then can query the descriptor resultant table 440 to produce reports 445 about each product or service, including data on whether the product or service receiving positive or negative feedback overall.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the disclosed system may conform to any of the various current implementations and practices known in the art. Another customer feedback system is described in U.S. Pat. No. 7,058,625, hereby incorporated by reference.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for managing customer feedback, comprising:
receiving a recording of spoken customer feedback in a server data processing system;
transcribing the customer feedback in the server data processing system to produce a transcript;
storing the transcript in a customer feedback database;
generating and storing an index of the transcript;
identifying words in the transcript that correspond to predefined keywords; and
generating a report according to the identified words and the transcript.

2. The method of claim 1, further comprising receiving the recording of spoken customer feedback from a digital recording device.

3. The method of claim 1, wherein the recording is received by the server data processing system over a network from a host data processing system.

4. The method of claim 1, further comprising generating recommendations according to the identified words.

5. The method of claim 1, wherein the index identifies one or more transcripts for each of a plurality of words in the index.

6. The method of claim 1, wherein the index is a combined index of a plurality of transcripts.

7. The method of claim 1, wherein the spoken customer feedback is recorded in a digital recording device.

8. The method of claim 1, wherein the predefined keywords include at least one of product or service identifiers, pricing identifiers, quality of goods or services identifiers, and customer satisfaction identifiers.

9. The method of claim 1, wherein the server data processing system receives recordings from a plurality of different host data processing systems.

10. The method of claim 1, further comprising storing the report.

11. A data processing system comprising a processor and accessible storage, the data processing system configured to perform the steps of:
receiving a recording of spoken customer feedback;
transcribing the customer feedback to produce a transcript;
storing the transcript in a customer feedback database in the storage;
generating and storing an index of the transcript;
identifying words in the transcript that correspond to predefined keywords; and
generating a report according to the identified words and the transcript.

12. The data processing system of claim 11, wherein the data processing system is further configured to receive the recording of spoken customer feedback from a digital recording device.

13. The data processing system of claim 11, wherein the recording is received by the data processing system over a network from a host data processing system.

14. The data processing system of claim 11, wherein the data processing system is further configured to generate recommendations according to the identified words.

15. The data processing system of claim 11, wherein the index identifies one or more transcripts for each of a plurality of words in the index.

16. The data processing system of claim 11, wherein the index is a combined index of a plurality of transcripts.

17. The data processing system of claim 11, wherein the spoken customer feedback is recorded in a digital recording device.

18. The data processing system of claim 11, wherein the predefined keywords include at least one of product or service identifiers, pricing identifiers, quality of goods or services identifiers, and customer satisfaction identifiers.

19. The data processing system of claim 11, wherein the server data processing system receives recordings from a plurality of different host data processing systems.

20. The data processing system of claim 11, wherein the data processing system is further configured to store the report.
